(19) United States
(12) Patent Application Publication
(10) Pub. No.: US 2025/0100935 A1
(43) Pub. Date: Mar. 27, 2025

(54) CHEMICAL ACTIVATION OF CALCINED CLAYS

(71) Applicant: CEMENTOS ARGOS S.A., Medellín (CO)

(72) Inventor: María Fernanda DÍAZ BURBANO, Medellín (CO)

(21) Appl. No.: 18/892,019

(22) Filed: Sep. 20, 2024

Related U.S. Application Data
(60) Provisional application No. 63/584,212, filed on Sep. 21, 2023.

(51) Int. Cl. C04B 28/26; C04B 22/06; C04B 28/00; C04B 40/00; C04B 103/10

(52) U.S. Cl. CPC C04B 28/26; C04B 22/062; C04B 28/001; C04B 40/0042; C04B 2103/10

(57) ABSTRACT

This development is related to a supplementary cementitious material (SCM) comprising previously calcined clay that has poor or moderately poor kaolinite content (with contents of kaolinite below 60%) and a chemical activator which, depending on the quality of the clay, is selected from a silicate, a strong base or a mixture of activators comprising a mixture of silicate-strong base.

### CROSS-REFERENCE TO RELATED APPLICATIONS

This application claims priority from U.S. Provisional Application 63/584,212 filed on Sep. 21, 2023, which is incorporated herein by reference in its entirety.

### TECHNICAL FIELD

The present invention is in the field of construction industry materials. Particularly supplementary cementitious materials (SCM) produced from low and medium quality materials such as calcined clays.

### BACKGROUND OF THE INVENTION

Supplementary cementitious materials (SCM) have been described in papers and patents throughout history. SCMs are inorganic materials compound mainly by alumina and silica that contribute to the properties of hardened cementitious materials through hydraulic activity, pozzolanic activity, or both. Typically, SCMs replace part of Portland cement that is in the main component of a concrete mixture, those SCMs are generally byproducts of other industries or natural materials, such as natural pozzolans, metakaolin or calcined clay. Currently, there is a high demand for clays suitable of activation to be included as SCM in cements.

For example, the construction material composition disclosed in U.S. Pat. No. 10,544,060 comprises a matrix predominantly containing an aluminosilicate compound, preferably metakaolin, and an alkaline activating solution. Said matrix has a “fast” metakaolin (“flashed” metakaolin) produced by calcining powdered clay at a temperature between 60° and 900° C. for a few seconds, followed by rapid cooling. On the other hand, the alkaline activating solution comprises a sodium or potassium silicate source and an alkaline base, such as NaOH and/or KOH.

On the other hand, patent U.S. Pat. No. 4,642,137 describes a binder composition for use in conjunction with Portland cement comprising 100 parts metakaolin (produced by dehydroxylation of kaolinite by heating to 500° C., preferably between 600° C. and 800° C.), 20 to 70 parts of slag, 85 to 130 parts of at least one material selected from fly ash, calcined shale, and calcined clay; 70 to 215 parts of finely divided silica, 50 to 145 parts of at least one material selected from potassium silicate and potassium hydroxide, wherein there are at least 55 parts of potassium silicate.

The available solutions previously disclosed include metakaolin as a starting material, metakaolin is a mineral rich in kaolinite (above 80% of kaolinite content) previously subjected to thermal activation. However, none of the above documents discloses compositions or SCM that include clay with alleged low pozzolanic activity potential, reaching the desired properties without affecting its physical characteristics such as high initial resistance at 2 days greater than 45 MPa, greater durability when cement or concrete is designed with this material and, faster hydration, compared to traditional SCM. Developing this type of material is interesting, among other reasons, because there is a more favorable cost-benefit ratio by using clays with low kaolinite content and then less demand in the market compared with pure kaolin sources and natural resources with the greatest demand are not exhausted, helping in confronting the over-exploitation of natural resources.

### SUMMARY OF THE INVENTION

The technical development described herein corresponds to a supplementary cementitious material (SCM) comprising a clay previously calcined and a chemical activator selected between a silicate, a strong base, or a mixture thereof. The previously calcined clay has low or moderate amounts of kaolinite.

### BRIEF DESCRIPTION OF THE DRAWINGS

FIG. 1 Chemical activation with a strong base (NaOH) at different molarities (4M, 6M, 8M, 10M, and 12M) of low kaolinite content clays at traditional calcination conditions between 600 and 900° C. Compressive strength of 7d pastes (MPa).

FIG. 2 Chemical activation with a strong base (NaOH) at different molarities (10M and 12M), mixtures of a strong base and silicate (NaOH and Na₂SiO₃) of low, medium, and rich content of kaolinite clays at typical calcined conditions between 600-900° C. Compressive strength of 7d pastes (MPa).

### DETAILED DESCRIPTION

Terms used in the following description have the meanings normally given to them in the technical field unless this description or the context clearly indicates otherwise. Where appropriate, terms used in the singular form shall also include the plural form. Unless otherwise indicated, by either contextual implications or customary practices, all parts and percentages in the present description are based on weight. The term “approximately” means variations of +5% of the defined value.

The present development corresponds to an improved supplementary cementitious material (SCM) comprising previously calcined clays activated by chemical activators. The chemical activators would vary depending on the quality of the clay and are selected from a silicate, a strong base, or a mixture of activators comprising a mixture of silicate-strong base.

### Supplementary Cementitious Material (SCM)

Supplementary cementitious materials (SCM) are used to reduce the clinker amount in cementitious materials. In general, the term cementitious material is defined as that material capable, in some cases by itself or in combination with other cementitious materials, of forming hydration products such as calcium silicate hydrates (C—S—H), aluminosilicate hydrates (A-S—H) or calcium aluminosilicate hydrates (C-A-S—H). Cementitious material includes Portland cement, fly ash, natural or artificial pozzolans, silica fume, and granulated blast furnace slag (GGBFS).

The use of the term supplementary refers to the function of supplementing or complementing the properties that these materials have in relation to cement, since they can enhance said properties or, in certain cases, make up for some of its deficiencies to comply with the technical specifications of a project.

Due to the nature of raw clays, different types of compositions and colors can be found, each with different levels of purity and variable mineral content which may be presumed as unfavorable for use in building materials as SCM. This is the case of those raw clays with low/poor or medium/moderate levels of kaolinite compared with the requirements for ceramic or paint industry for example, since it is the main mineral for which clay is still widely used.

Raw clays can correspond to a mixture of several minerals with different characteristics or pure clay with only one mineral. Raw clay (without being subjected to a thermal activation process) comprise one or more of the following clay minerals: gibbsite, goethite, montmorillonite, kaolinite, chlorites, micas, muscovites, halloysite, metahalloysite, and quartz or mixtures thereof. However, raw clays have complex mineralogy, due to the presence of clay minerals such as kaolinite, montmorillonite, halloysite, and illite.

In connection with the present development, the clay has little or no preference in thermal and/or chemical activation processes due to its low or medium content of kaolinite, however after calcination, it is further activated chemically by chemical activators. Therefore, the clays used in this development correspond to previously calcined clays, however, when talking about their kaolin content it is in the raw clay. Preferably, the calcined clays used in the present invention should have amorphous Silica (Si) and Alumina (Al), or at least 40% reactive Si.

The kaolinite content, the reactivity, and the presence of a strong chemical activator reach a synergy that causes the chemical elements to solubilize, and the reaction (between silicates, aluminates, calcium, water to form the CSH and CASH, mentioned above) to occur, and the phases responsible for generating resistance in the material to be formed.

### Kaolinite Content

In a preferred embodiment, the clay used in the supplementary cementitious material generally has no preference in thermal or chemical activation processes. Without the aim of compelling to a particular reason, it is possible that it is because the clays do not have the desired amounts of kaolinite (higher than 60%), and on the contrary, it has low or medium amounts of kaolinite (below 60%). The above values are by weight of the crystalline phases of the clay.

Kaolinite is a clay mineral, with the chemical composition Al₂Si₂O₅ (OH)₄ however the amount of kaolinite in each clay may vary. Therefore, the clays can be divided into three broad categories, rich kaolinite clay content, moderate kaolinite clay content, and poor kaolinite clay content. According to our experience in clays and using a X-ray diffraction (XRD) analysis, we define the type of clays as a rich kaolinite clay corresponds to those clays with kaolinite content above 60%, a medium kaolinite clay corresponds to those clays with kaolinite content between 40% and 60%, preferably between 40% and 55%, finally, the low kaolinite clay corresponds to those clay with kaolinite content below 40% kaolinite, preferably between 10 and 40% kaolinite.

Even though the present development can include rich kaolinite content clays, in a preferred embodiment it is directed to clays that are medium and poor kaolinite clays with a maximum of 60% kaolinite.

Without the aim of compelling to a particular reason, the activation results of moderate or poor clays are not predictable due to their low kaolinite content and the presence of clay minerals such as montmorillonite, halloysite, and illite, as well as low amorphous, reactive Silica and Alumina reactivity, which may favor activation. In addition, these characteristics may vary depending on the geological formation and the heat treatment to which clays are subjected.

### Calcination

Calcination causes thermal decomposition or a change of state in the physical or chemical constitution of the material. In this case, the clays useful in the present invention are previously calcined under traditional conditions, that is between 60° and 900° C. to achieve the formation of amorphous/reactive phases. As mentioned above, clays with low or moderate content of kaolinite do not tend to easily activate, however, the inventors surprisingly found out that when combining kaolinite conditions with chemical activators in specific relation, they can be activated.

The present development includes clays that were thermally activated previously. Particularly the clays were calcined at temperatures higher than 600° C., more particularly between 600° C. and 900° C., between 600° C. and 800° C., or preferably between 70° and 900° C.

### Chemical Activation

Chemical activation is a technology focused on potentiating or activating supplementary cementitious materials such as blast furnace slag and fly ash, to increase their participation in cement and concrete recipes. However, natural pozzolans are even more abundant and available resources but, as mentioned above, chemical activation of these materials has been a challenging due to their complex mineralogy, such as the presence of clay minerals such as kaolinite, montmorillonite, halloysite, and illite, which can absorb water and affect the mechanical performance and workability of the cement and resulting concrete. On the other hand, the amorphous content is also a limitation.

Therefore, contrary to expectations, the present development manages to find a way to perform an activation of clays with the characteristics described above (previously calcined at regular temperatures and with preferably low or moderate kaolinite content) by chemical activation with a chemical activator.

A chemical activator is a substance that facilitates the initiation of the chemical reaction between aluminosilicates and water. This reaction allows SCM to improve or enhance the properties of cementitious mixtures, such as, hydroxides of alkali metals and alkaline earth metals. For the present development, the chemical activator is selected between a silicate, a strong base or a mixture thereof. The silicates are selected from, but are not limited to alkaline silicates, quartz (SiO₂), sodium silicate (Na₂SiO₃), potassium silicate (K₂SiO₃), lithium silicate (Li₂SiO₃), magnesium silicate (MgSiO₃), calcium silicate (CaSiO₃), aluminum silicate (Al₂SiO₅), zinc silicate (Zn₂SiO₄), and barium silicate (BaSiO₃), among others. The strong base is selected from, but is not limited to sodium hydroxide (NaOH), potassium hydroxide (KOH), lithium hydroxide (LiOH), rubidium hydroxide (RbOH), cesium hydroxide (CsOH), calcium hydroxide (Ca(OH)₂), barium hydroxide (Ba(OH)₂), strontium hydroxide (Sr(OH)₂), sodium methoxide (CH₃OH)₂), potassium methoxide (CH₃OK), sodium methoxide (NaOMe), lithium diisopropylamide (LDA), and potassium amide (KNH₂), among others. Preferably, the strong bases are selected from NaOH, KOH, CaOH, and the silicates are alkaline silicates selected from sodium silicate (Na₂SiO₃), calcium silicate (Ca₂O₄Si), magnesium silicate (MgSiO₃) or potassium silicate K₄ (SiO₄). The molarity of the chemical activator is between 8 and 12M. In one embodiment, the chemical activator is a mixture of at least one silicate and at least one strong base, preferably NaOH and Na₂SiO₃.

In one embodiment, the silicate-strong base ratio is between 60:40 and 90:10 (silicate:strong base). While activator mix ratios outside of this range might activate the clay, they would not activate as much as in the preferred range.

The activator can be in a solid or liquid state and can include components such as hydroxides, silicates, sulfates, chlorides, alkanolamines, polycarboxylates, glycerol, glycols, and acids, among others. The challenge of solid activators is that these require investment for their implementation; associated with dosing hoppers, however, liquid activators are easier to dose and therefore require a low investment in equipment, that is, these are dosed very similarly to typical grinding additives.

### Liquid Solid Ratio

One of the parameters that the inventors found useful to finally activate the calcined clays is a ratio between the chemical activator and the calcined clay. This means the amount of chemical activator depends on the amount of calcined clay, but the chemical activator is in liquid form while the calcined clay is in solid form. Thus, the liquid/solid (L/S) ratio is between 0.2 and 0.6, or between 0.2 and 0.5, between 0.3 to 0.5, between 0.4 to 0.6, or between 0.4 to 0.5. If the L/S ratio is below 0.2, the results are not good, they do not generate resistance and if it is above 0.6, perhaps they are expensive formulations or they may also affect the resistance. In another embodiment, the chemical activator is in solid form as the super calcined clay. Thus, the percentage of the chemical activator in the mixture is between 1 to 15%.

Preferably, when the calcined clay is a poor clay, that is it has a kaolinite content percentage below 40%, below 35%, or between 20% and 30%, the chemical activator is a strong base. Preferably, when the calcined is medium kaolinite clay, that is it has a kaolinite content percentage higher than 40%, higher than 35%, or between 35 and 50%, the chemical activator is a mixture of a silicate and a strong base.

### Uses

The present development is directed to a pozzolanic mixture useful as supplementary cementitious material (SCM), for example, in the formulation of a cementitious composition and in the formulation of pastes, mortars, and concretes, among others. The SCM described herein may be formulated into a pozzolanic-type cement, blended, or composite cement, general use cement (GU), high early strength (HE), moderate/mild sulfate strength (MS), high sulfate strength (HS), moderate heat of hydration (MH), low heat of hydration (LH), structural cement, concrete cement, soil cement, and masonry. For example, different HE, GU, MS, and MH cements may be proportioned in accordance with ASTM C1157.

### Method for Preparing a SCM

Method for the preparation of a supplementary cementitious material which comprises mixing previously calcined clay with a chemical activator; wherein the previously calcined clay was calcined at temperatures between 600° C. and 900° C. having poor or moderate kaolinite content in the raw clay, and wherein the chemical activator is selected from a silicate, a strong base, sulfates, chlorides, alkanolamines, polycarboxylates, glycerol, glycols, and acids, among others or a mixture thereof. The chemical activator (liquid) and the previously calcined clay (solid) are mixed at a liquid/solid (L/S) ratio between 0.2 and 0.6.

Method for utilizing the SCM to produce pastes

The method here described comprises the following steps:
Preparing a mixture of previously calcined clay and a chemical activator according to the development already described;
Mixing cementitious composition components, water, and admixtures (if necessary, depending on the desired performance properties) with the previously calcined clay and chemical activator mix of the invention to obtain a uniform paste.

Unlike mortar, sand is not included in the mixture to produce a paste. The cementitious composition components include, but are not limited to clinker, at least one setting regulator, a cement additive, and an inert filler such as limestone.

In another embodiment, the method for utilizing the SCM to produce pastes comprises mixing a previously over-calcined clay, a chemical activator, cementitious composition components, water, and admixtures (if necessary) in a single step.

Method for utilizing the SCM to produce mortars

The method here described comprises the following steps:
Preparing a mixture of previously calcined clay and a chemical activator according to the development already described;
Mixing cementitious composition components, sand, water, and admixtures (if necessary, depending on the desired performance properties), with the previously calcined clay and chemical activator mix of the invention until a homogeneous mortar is obtained.

The cementitious composition components include, but are not limited to, clinker, at least one setting regulator, a cement additive, and an inert filler such as limestone.

In another embodiment, the method for utilizing the SCM to produce mortars comprises mixing a previously calcined clay, a chemical activator, cementitious composition components, sands, water and admixtures (if necessary) in a single step.

Method for utilizing the SCM to produce concrete

The method here described comprises the following steps:
Preparing a mixture of previously calcined clay and a chemical activator according to the development already described;
Mixing cementitious composition components, fine aggregates, coarse aggregates, water, and chemical admixtures (such as superplasticizers, as needed) with the previously calcined clay and chemical activator mix until homogeneously blended, to achieve the desired concrete consistency and workability.

The cementitious composition components include, but are not limited to, clinker, at least one setting regulator, a cement additive, and an inert filler such as limestone.

In another embodiment, the method for utilizing the SCM to produce concrete comprises mixing a previously calcined clay, a chemical activator, cementitious composition components, fine aggregates, coarse aggregates, water, and chemical admixtures (if necessary) in a single step.

The present development will be presented in detail through the following examples, which are provided for illustrative purposes only and are not intended to limit its scope.

### EXAMPLES

### Example 1. Characterization of Raw Clays

Raw clay (clays that have not been subjected to calcination) samples were subjected to chemical analysis. Clays with high Si, Al, and Fe, contents and low Loss of Ignition (LOI) value are sought, and preferably with reactive Si and Al with XFR, however it does not necessarily mean that Si and Al are reactive and to find out that we go on to other tests, such as XRD.

TABLE 1
Chemical analysis of rich, medium, and low
kaolinite clays without calcination (XRF)

| | Rich kaolinite | Medium kaolinite | Low kaolinite |
|---|---|---|---|
| | raw clay | raw clay | raw clay |
| LOI | 16.21 | 9.65 | 7.93 |
| SiO₂ | 42.77 | 53.41 | 60.66 |
| Al₂O₃ | 37.42 | 23.42 | 19.02 |
| Fe₂O₃ | 1.11 | 9.91 | 8.14 |
| Si + Al + Fe | 81.30 | 86.74 | 87.82 |

LOI = Loss of Ignition

TABLE 2
X-Ray Diffraction (XRD) raw clays

| | Rich kaolinite | Medium kaolinite | Low kaolinite |
|---|---|---|---|
| | raw clay | raw clay | raw clay |
| Quartz low | 5% | 35% | 64% |
| Hematite | 1% | 0% | 0% |
| Kaolinite | 63% | 45% | 19% |
| Muscovite | 0% | 17% | 31% |
| Anatase | 3% | 0% | 0% |
| Gibbsite | 11% | 3% | 5% |
| Dickite | 17% | 0% | 0% |

TABLE 3
Reactive Si in raw clays

| Name sample | % reactive SiO₂ |
|---|---|
| Rich kaolinite clay without calcining | 42.57 |
| Low kaolinite clay without calcining | 41.63 |

The previous analyses are carried out to know the quality of the raw materials, through their chemistry, mineralogy, and reactivity of phases such as silica, which generate a starting point to potentiate the material using thermal and chemical activation. From the previous tables it can be concluded that although the chemical analysis shows high levels of Si and Al, it is necessary to know how Si and Al are found, if it is in a crystalline phase it would not be expected to be very reactive, but if Si and Al are in the amorphous or reactive phase, it is a condition to achieve a greater activation of the material.

### Example 2. Characterization of Calcined Clays

The clays described in Example 1 were subjected to calcination, particularly at temperatures of 700 and 850° C. approximately, below are the chemical characterization of those clays.

TABLE 4
Chemical characterization of calcined clays

| | Kaolinite content | | |
|---|---|---|---|
| | Rich | Medium | Poor |
| LOI | 4.40 | 3.02 | 1.62 |
| SiO₂ | 48.84 | 56.05 | 64.61 |
| TiO₂ | 2.17 | 0.96 | 1.18 |
| Al₂O₃ | 42.24 | 25.68 | 20.13 |
| Fe₂O₃ | 1.49 | 11.92 | 8.92 |
| Mn₃O₄ | 0.01 | 0.01 | 0.07 |
| MgO | 0.11 | 0.41 | 0.48 |
| CaO | 0.10 | 0.07 | 0.23 |
| Na₂O | 0.26 | 0.39 | 0.35 |
| K₂O | 0.06 | 1.15 | 2.06 |
| P₂O₅ | 0.10 | 0.14 | 0.10 |
| SO₃ | 0.03 | 0.02 | 0.06 |
| Si + Al + Fe | 92.56 | 93.65 | 93.66 |

When raw clay is subjected to a typical temperature ramp (between 600 and 900° C.), it experiences weight loss associated with the evaporation of water that occurs at 100° C., followed by 400° C. where the clay minerals (hydroxyl groups (OH) are destroyed.) and a destabilization of the system is formed. At approximately 600° C. the decarbonation process is carried out. All these mass losses are represented by a lower LOI compared to the results for raw clay in Table 1.

TABLE 5
Amount of amorphous depending on the calcination temperature

| Amorphous | Raw | Calcined |
|---|---|---|
| content | (without calcination) | (Average) |
| Rich | 61.2% | 78.35 |
| Medium | 43.1% | 57.30 |
| Poor | 41.6% | 25.85 |

### Example 3. Alkaline Activation of Calcined Clays and Results Obtained

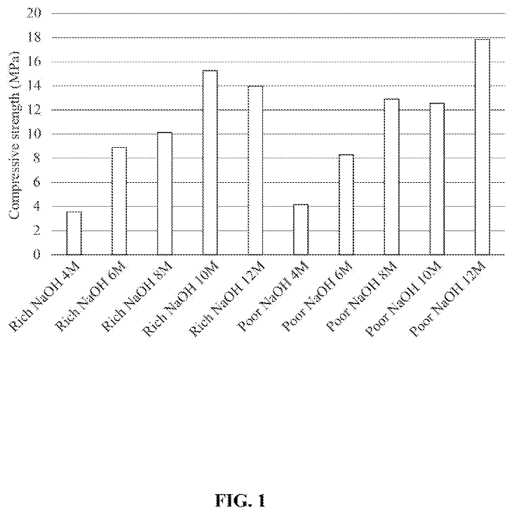

Previously calcined clay samples with medium kaolinite content, when they were raw clay, were chemically activated with NaOH, the compressive strength results are summarized in FIG. 1. As an outstanding result, it can be seen in FIG. 1 that poor kaolinite content clays obtained similar results to rich kaolinite content clays, this information es relevant since clays without the proposed chemical activation usually show compressive strength between 2 and 3 MPa, wherein amounts above 10 MPa are already considered improved. In this case, at least for samples of the 5 tested.

### Example 4. Chemical Activation of Calcined Clays and Results Obtained

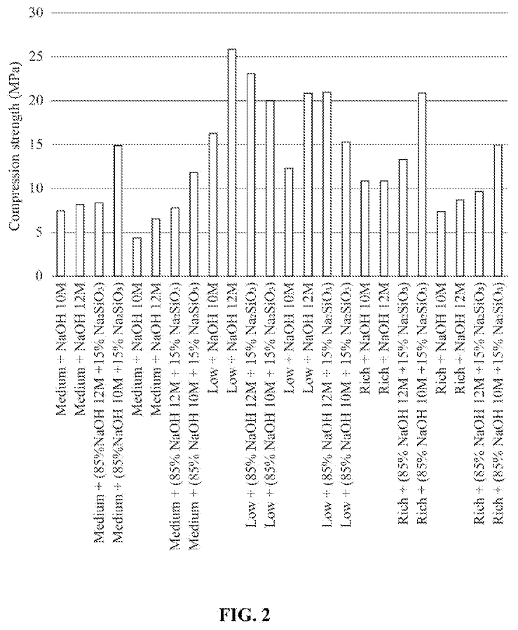

Mixtures of activators with the preferred results of NaOH obtained in Example 3, were mixed with Na₂SiO₃ in different amounts and concentrations. The results are shown in FIG. 2 which were dosed with an L/S ratio between 0.3 and 0.5 looking for appropriate hydration of the cementing material, in this case, the calcined clay. The proposed mixture of activators also activates the clays which is a valid activation option since they all gave better results than clay without activation, as described above.

Poor and moderate kaolinite content, as expected, have lower contents of amorphous or reactive phase than clays rich in kaolinite after calcination (as shown in Examples 1 and 2); due to their low reactivity, they are not attractive for use as cementing agents, the inventors found that after subjecting them to a chemical activation, apparently the hydroxides, silicates, or a mixture of these activators increased their reaction potential.

### Example 5. Calcined Clay with Poor Kaolinite Content Activated with Strong Bases

Clay samples with poor kaolinite content (below 40%) particularly 35% were analyzed. The clays were calcined at a temperature between 60° and 900° C. A chemical activator that was a strong base, particularly NaOH was used with a molarity between 4 and 12, which was dosed with an L/S ratio between 0.3 and 0.5 looking for appropriate hydration of the cementing material.

This activation was successful because the clay with poor kaolinite content without chemical activation obtained a compressive strength of less than 2 MPa, however; the chemically activated clay achieved a compressive strength of up to 17 MPa under the same conditions.

What is claimed is:

1. A Supplementary Cementitious Material (SCM) comprising:
previously calcined clay at temperatures between 600° C. and 900° C. having poor or moderate kaolinite content in the raw clay; and
a chemical activator selected from a silicate, a strong base, or a mixture of activators;
wherein the chemical activator (liquid) and previously calcined clay (solid) have a liquid/solid (L/S) ratio between 0.2 and 0.6.

2. The SCM according to claim 1, wherein the poor kaolinite content includes kaolinite between 5% and 50% in the raw clay.

3. The SCM according to claim 2, wherein the poor kaolinite content has a kaolinite content percentage between 20% and 45% in the raw clay.

4. The SCM according to claim 3, wherein the poor kaolinite content has a kaolinite content percentage between 25% and 35% in the raw clay.

5. The SCM according to claim 1, wherein the moderate kaolinite content includes kaolinite between 35% and 60% in the raw clay.

6. The SCM according to claim 5, wherein the moderate kaolinite content has a kaolinite content percentage between 35% and 50% in the raw clay.

7. The SCM according to claim 1, wherein when the previously calcined clay has a kaolinite content percentage higher than 35%, the activator is a mixture of activators.

8. The SCM according to claim 7, wherein when the previously calcined clay has a kaolinite content percentage between 35% and 50%, the activator is a mixture of activators.

9. The SCM according to claim 1, wherein the mixture of activators is at least one silicate and at least one strong base.

10. The SCM of claim 1, wherein the activator is selected from sodium silicate (Na₂SiO₃), calcium silicate (Ca₂O₄Si), magnesium silicate, or K₄ (SiO₄) potassium silicate and the strong base is selected from sodium hydroxide (NaOH), potassium hydroxide (KOH), calcium hydroxide (CaOH), or magnesium hydroxide (Mg(OH)₂).

11. The SCM according to claim 9, wherein the silicate-strong base ratio is between 60:40 and 90:10 (silicate:strong base).

12. The SCM of claim 11, wherein the activator is between 70% and 90% strong base, and between 10% and 40% silicate.

13. The SCM of claim 11, wherein the activator is between 75% and 90% strong base, and between 15% and 25% silicate.

14. A method for preparing a supplementary cementitious material comprising:
mixing a previously calcined clay at temperatures between 600° C. and 900° C. having poor or moderate kaolinite content in the raw clay, with a chemical activator selected from a silicate, a strong base, or a mixture thereof;
wherein the chemical activator (liquid) and previously calcined clay (solid) have a liquid/solid (L/S) ratio between 0.2 and 0.6.

15. A method for preparing a mortar comprising:
preparing a mixture of a previously calcined clay and a chemical activator; and
mixing it with cementitious composition components, sand, water, and optionally admixtures;
wherein the clay was previously calcined at temperatures between 60° and 900° C. having poor or moderate kaolinite content in the raw clay; the chemical activator is selected from a silicate, a strong base or a mixture thereof; and wherein the chemical activator (liquid) and the previously calcined clay (solid) have a liquid/solid (L/S) ratio between 0.2 and 0.6.

16. A method for preparing concrete comprising:
preparing a mixture of a previously calcined clay and a chemical activator, and
mixing it with cementitious composition components, fine aggregates, coarse aggregates, water, and chemical admixtures;
wherein the clay was previously calcined at temperatures between 60° and 900° C. having poor or moderate kaolinite content in the raw clay; the chemical activator is selected from a silicate, a strong base or a mixture thereof; and wherein the chemical activator (liquid) and the previously calcined clay (solid) have a liquid/solid (L/S) ratio between 0.2 and 0.6.
